(19) United States
(12) Patent Application Publication
(10) Pub. No.: US 2012/0246713 A1
(43) Pub. Date: Sep. 27, 2012

(54) METHOD AND APPARATUS FOR CONTROLLING ACCESS OF A SECURE DIGITAL MEMORY CARD

(76) Inventors: Cheng-Hsiung Liao, Taipei City (TW); Tsang-Yi Chen, New Taipei City (TW)

(21) Appl. No.: 13/071,472

(22) Filed: Mar. 24, 2011

(51) Int. Cl. G06F 12/14

(52) U.S. Cl. 726/16

(57) ABSTRACT

A method for controlling access of a secure digital memory card includes inserting the secure digital memory card into a card reader; an electronic device performing an application program to detect whether a first password is stored in the secure digital card when a write protection function of the secure digital memory card is enabled; inputting a second password when the first password is not stored in the secure digital memory card; and sending a first command embedded with the second password to disable a read access function of the secure digital memory card.

### BACKGROUND

1. Technical Field

The present invention relates to a method for controlling access of a secure digital memory card, and more particularly, to a method for controlling read access of a secure digital memory card by a card reader.

2. Description of the Conventional Art

Generally, a secure digital memory card comprises a write protection switch for enabling or disabling a write protection function of the secure digital memory card. When a card reader detects the write protection function of the secure digital memory card is disabled, the card reader can not only read the data stored in the secure digital memory card, but also change the content of the data stored in the secure digital memory card. When the card reader detects the write protection function of the secure digital memory card is enabled, the card reader can only read the data stored in the secure digital memory card without making any change of the data.

### SUMMARY

A method for controlling access of a secure digital memory card is disclosed, which comprises inserting the secure digital memory card into a card reader, wherein the card reader is coupled to an electronic device; performing an application program to detect whether a first password is stored in the secure digital card when a write protection function of the secure digital memory card is enabled; inputting a second password when the first password is not stored in the secure digital memory card; and sending a first command embedded with the second password to disable a read access function of the secure digital memory card.

A card reader is also disclosed, which comprises a connection port for coupling to an electronic device; a card connector for coupling to the secure digital memory card; a memory for storing a command data; and a control unit coupled to the connection port, the card connector and the memory, for triggering the electronic device to perform an application program for requesting a password, and sending a command embedded with the password to the secure digital memory card for enabling/disabling a read access function of the secure digital memory card.

In addition, this disclosure provides an electronic device comprising a processor for performing an application program, and a card reader. The card reader comprises a card connector for coupling to the secure digital memory card; a memory unit for storing a command data; and a control unit coupled to the card connector, the memory unit and the processor, for triggering the processor to perform the application program for requesting a password, and sending a command embedded with the password to the secure digital memory card for enabling/disabling a read access function of the secure digital memory card.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a card reader of the present embodiment.

FIG. 2 is a diagram showing another card reader of the present embodiment.

FIG. 3 is a flowchart of the method of the present embodiment for enabling/disabling read access of the secure digital memory card.

### DETAILED DESCRIPTION

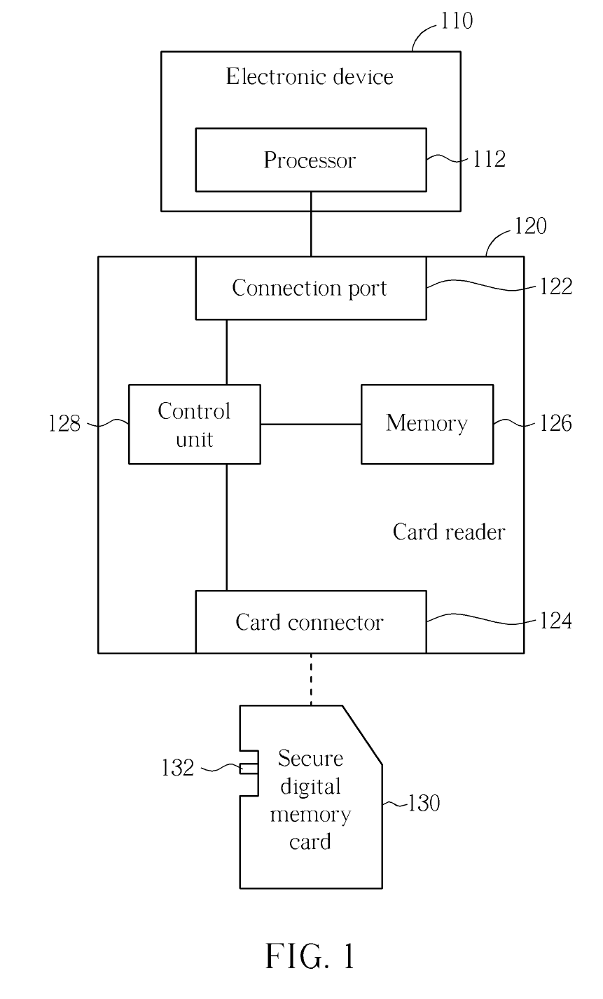

Please refer to FIG. 1, which is a diagram showing a card reader 120 of the present embodiment. The card reader 120 comprises a connection port 122, a card connector 124, a memory 126, and a control unit 128. The connection port 122 is for coupling to an electronic device 110, such as a computer or a mobile phone. The electronic device 110 comprises a processor 112 for performing an application program. The card connector 124 is for coupling to a secure digital memory card 130. The memory 126 is for storing a command data, which is a CMD42 command data defined by the secure digital association. The CMD42 command is capable of enabling/disabling read access of the secure digital memory card 130 with a password. The control unit 128 is coupled to the connection port 122, the card connector 124 and the memory 126. The control unit 128 is able to send a CMD42 command embedded with a password to the secure digital memory card 130 according to the application program. On the other words, the application program is used to encrypt the whole content of the secure digital memory card 130.

In the present embodiment, in order to disable a read access function of the secure digital memory card 130, the write protection switch 132 of the secure digital memory card 130 must be switched on to enable the write protection function first for triggering the application program. The above arrangement can prevent triggering the application program unintentionally. When the secure digital memory card 130 is coupled to the card connector 124, the control unit 128 detects whether the write protection function of the secure digital memory car 130 is enabled. If the write protection function of the secure digital memory car 130 is enabled, the control unit 128 triggers the electronic device 110 to perform the application program. The application program then asks the user whether he want to continue the following processes of the application program. If the user doesn't intend to control the read access function of the secure digital memory card 130, the user can close the application program, and the secure digital memory card 130 is in a normal read-only state as the write protection function of the secure digital memory car 130 is enabled. If the user select to continue the application program, the application program then detects whether a first password is stored in the secure digital memory card 130. If the first password is not stored in the secure digital memory card 130 (which means the read access function of the secure digital memory car 130 is still enabled) , the application program requests a second password. After inputting the second password, the control unit 128 sends a first command embedded with the second password to disable the read access function of the secure digital memory card 130. The secure digital memory card 130 stores the second password for enabling the read function later.

Optionally, the application program is performed to directly detect whether a first password is stored in the secure digital memory card 130 without providing selections to the users when the write protection function of the secure digital memory car 130 is enabled.

After disabling the read access function of the secure digital memory card 130, all data stored in the secure digital memory card 130 cannot be read unless the read access function of the secure digital memory card 130 is enabled again.

On the other hand, after the step of detecting whether the first password is stored in the secure digital memory card 130, if the first password is already stored in the secure digital memory card 130 (which means the read access function of the secure digital memory car 130 is already disabled), in order to enable the read access function of the secure digital memory card 130, the application program requests a third password. After inputting the third password, the application program compares the third password with the first password stored in the secure digital memory card 130. If the third password is consistent with the first password stored in the secure digital memory card 130, the control unit 128 sends a second command to enable the read access function of the secure digital memory card 130.

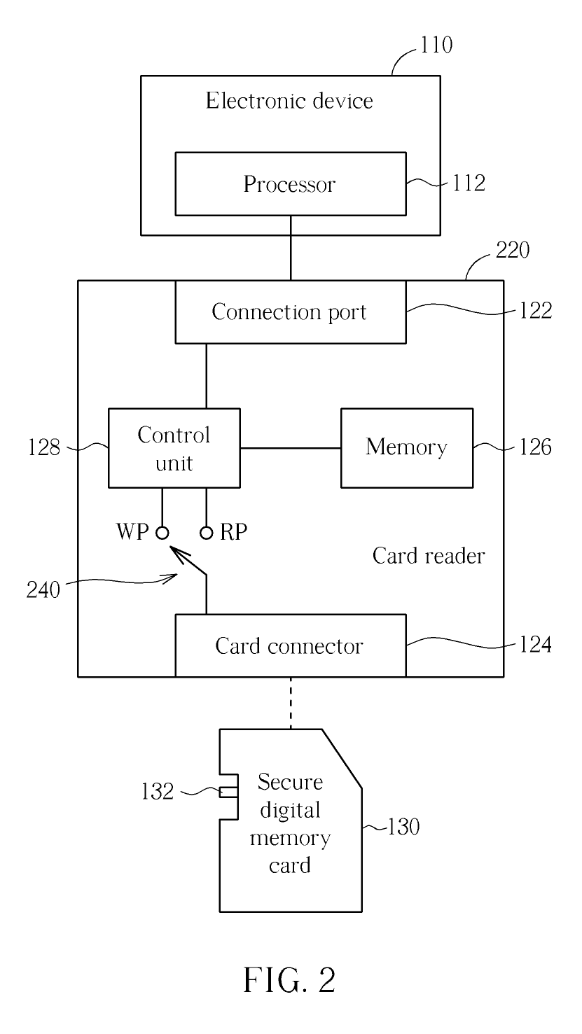

Please refer to FIG. 2, which is a diagram showing another card reader 220 of the present embodiment. Different from the card reader 120 of FIG. 1, the card reader 220 further comprises a mechanical switch, for example a switch 240 for selecting if the application program is to be triggered by the write protection switch 132 of the secure digital memory card 130. If the switch 240 is switched to a read protection position RP, the application program will be triggered when the write protection switch 132 of the secure digital memory card 130 is switched on. On the contrary, if the switch 240 is switched to a write protection position WP, the application program won't be triggered when the write protection switch 132 of the secure digital memory card 130 is switched on. In the situation of the write protection switch 132 of the secure digital memory card 130 is switched off, then the switch 240 will have no function to the secure digital memory card 130, and the application program won't be triggered either.

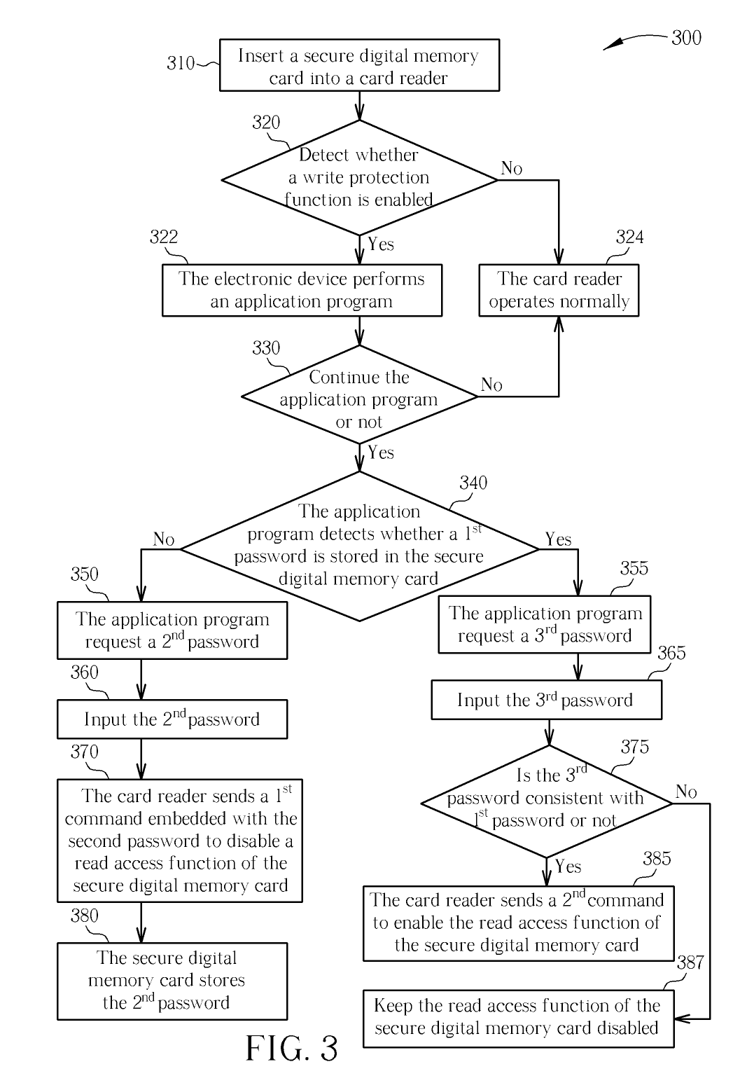

Please refer to FIG. 3, which is a flowchart 300 of the method of the present embodiment for enabling/disabling the read access function of the secure digital memory card 130. The flowchart 300 comprises the following steps:

Step 310: Insert a secure digital memory card into a card reader, the card reader is coupled to an electronic device;

Step 320: Detect whether a write protection function of the secure digital memory card is enabled;

Step 322: If the write protection function of the secure digital memory card is enabled, the electronic device performs an application program;

Step 324: The card reader operates normally;

Step 330: Select if the application program is to be continued;

Step 340: If select to continue the application program, the application program detects whether a first password is stored in the secure digital memory card;

Step 350: If the first password is not stored in the digital memory card, the application program request a second password;

Step 360: Input the second password;

Step 370: The card reader sends a first command embedded with the second password to disable a read access function of the secure digital memory card;

Step 380: The secure digital memory card stores the second password.

Step 355: If the first password is stored in the digital memory card, the application program request a third password;

Step 365: Input the third password;

Step 375: Compare the third password with the first password to determine whether the third password is consistent with the first password;

Step 385: If the third password is consistent with the first password stored in the secure digital memory card, the card reader sends a second command to enable the read access function of the secure digital memory card; and

Step 387: If the third password is not consistent with the first password stored in the secure digital memory card, keep the read access function of the secure digital memory card disabled.

Basically, to achieve the same result, the steps of the flowcharts 300 need not be in the exact order shown and need not be contiguous, that is, other steps can be inserted therebetween, such as installing the application program to the electronic device, and detecting whether the write protection function of the secure digital memory car is enabled.

In addition, although the card readers 120, 220 described above are peripheral devices of the electronic device 110, the card readers 120, 220 can also be embedded in the electronic device 110. The secure digital memory card 130 mentioned above is a memory card complied with secure digital memory card specifications, such as an SD memory card, an SDHC memory card or an SDXC memory card, etc.

In contrast to the prior art, the present embodiment provides a method for controlling read access of the secure digital memory card. Moreover, the card reader of the present embodiment is capable of triggering the application program when the write protection function of the secure digital memory car is enabled, in order to enable/disable the read function of the secure digital memory card.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling access of a secure digital memory card, comprising:
inserting the secure digital memory card into a card reader, wherein the card reader is coupled to an electronic device;
performing an application program to detect whether a first password is stored in the secure digital card when a write protection function of the secure digital memory card is enabled;
inputting a second password when the first password is not stored in the secure digital memory card; and
sending a first command embedded with the second password to disable a read access function of the secure digital memory card.

2. The method of claim 1 further comprising:
storing the second password in the secure digital memory card.

3. The method of claim 1, before the step of performing the application program further comprising:
detecting whether the write protection function of the secure digital memory card is enabled.

4. The method of claim 3 further comprising:
providing a selection for deciding whether to perform the application program.

5. The method of claim 1, after the step of performing the application program further comprising:
inputting a third password when the first password is stored in the secure digital memory card;
comparing the third password and the first password; and
enabling the read access function of the secure digital memory card when the third password is consistent with the first password.

6. The method of claim 5, wherein the step of enabling the read access function of the secure digital memory card is performed by sending a second command to the secure digital memory card by the card reader.

7. The method of claim 1, before the step of performing the application program further comprising:
installing the application program to the electronic device.

8. A card reader capable of controlling access of a secure digital memory card, comprising:
a connection port for coupling to an electronic device;
a card connector for coupling to the secure digital memory card;
a memory for storing a command data; and
a control unit coupled to the connection port, the card connector and the memory, for triggering the electronic device to perform an application program for requesting a password, and sending a command embedded with the password to the secure digital memory card for enabling/disabling a read access function of the secure digital memory card.

9. The card reader of claim 8 further comprising a switch for selecting if the application program is to be triggered.

10. The card reader of claim 8, wherein the secure digital memory card is a memory card complied with secure digital memory card specifications.

11. An electronic device capable of controlling access of a secure digital memory card, comprising:
a processor for performing an application program; and
a card reader comprising:
a card connector for coupling to the secure digital memory card;
a memory unit for storing a command data; and
a control unit coupled to the card connector, the memory unit and the processor, for triggering the processor to perform the application program for requesting a password, and sending a command embedded with the password to the secure digital memory card for enabling/disabling a read access function of the secure digital memory card.

12. The electronic device of claim 11 further comprising a switch for selecting if the application program is to be triggered.

13. The electronic device of claim 11, wherein the secure digital memory card is a memory card complied with the secure digital memory card specifications.
